(19) United States
(12) Patent Application Publication
(10) Pub. No.: US 2026/0271061 A1
(43) Pub. Date: Sep. 10, 2026

(54) METHOD AND APPARATUS FOR PROCESSING DATA ASSOCIATED WITH A PLURALITY OF RADIO CHANNELS

(71) Applicant: Robert Bosch GmbH, Stuttgart (DE)

(72) Inventors: Sebastian Lindner, Hamburg (DE); Marie-Theres Suer, Braunschweig (DE); Maximilian Stark, Hamburg (DE)

(21) Appl. No.: 19/535,228

(22) Filed: Feb. 10, 2026

(30) Foreign Application Priority Data
Mar. 5, 2025 (DE) 10 2025 108 374.6

(51) Int. Cl. H04W 74/0808; H04B 17/318; H04W 74/08

(52) U.S. Cl. CPC H04W 74/0808; H04B 17/328; H04W 74/0875

(57) ABSTRACT

A method for processing data associated with a plurality of radio channels. The method includes: assigning a respective different priority to each of the plurality of radio channels; performing a respective sensing operation for each of the plurality of radio channels based on the respective assigned priority.

### CROSS REFERENCE

The present application claims the benefit under 35 U.S.C. § 119 of Germany Patent Application No. DE 10 2025 108 374.6 filed on March 5, 2025, which is expressly incorporated herein by reference in its entirety.

### FIELD

The present disclosure relates to a method for processing data associated with a plurality of radio channels.

The present disclosure further relates to an apparatus for processing data associated with a plurality of radio channels.

### SUMMARY

Some examples of the present disclosure relate to a method, for example a computer-implemented method, for processing data associated with a plurality of radio channels, the method comprising: assigning a respective different (e.g., individual) priority to each of the plurality of radio channels, performing a respective sensing operation for each of the plurality of radio channels based on the respective assigned priority. In some examples, this may enable to adapt a sensing procedure or strategy to a priority associated with a respective radio channel. In some examples, the radio channels may at least temporarily be used for communication, e.g., as communication channels. The radio channels may be part of or assigned to a wireless communication system, e.g., according to 3GPP or IEEE specifications, such as a cellular mobile communication system or a Wi-Fi communication system.

The method may be performed by a data processing apparatus or a device of the wireless communication system. Specifically, the method may be understood as a method for operating the data processing apparatus or the device, particularly for performing (radio channel) sensing of a wireless communication system, preferably for acquiring information about a current state or quality of the respective radio channel.

In some examples, performing the respective sensing operation for each of the plurality of radio channels comprises performing the respective sensing operation for each of the plurality of radio channels in a sequence associated with the respective assigned priority, wherein for example the sequence is arranged in order of decreasing priority.

In some examples, the method comprises: determining the different priorities for the plurality of radio channels based on at least one of: a) an information gain associated with the respective radio channel, or b) a time since the respective radio channel was last sensed.

In some examples, determining the different, e.g., individual, priorities for the plurality of radio channels may comprise receiving the respective priorities, e.g., from at least one further device or entity.

In some examples, determining the different, e.g., individual, priorities for the plurality of radio channels may comprise determining the respective priorities, e.g., locally, e.g., by an apparatus performing at least one aspect of the method according to the principle of the disclosure.

In some examples, the method comprises: determining the information gain associated with the respective radio channel based on a change of a channel quality associated with the respective radio channel, e.g., based on a difference of a

channel quality, e.g., before and after sensing, e.g., according to at least one predetermined scheme, also see some examples disclosed further below.

In some examples, the method comprises: determining first information characterizing a respective quality of the respective radio channel based at least on the sensing operations, wherein for example the determining comprises organizing the first information in the form of a list, for example a channel quality list.

In some examples, the method comprises: performing a first sensing procedure for sensing the plurality of radio channels using a first scheme, wherein for example the first scheme is independent of the respective priority of each of the plurality of radio channels, performing a second sensing procedure for sensing the plurality of radio channels using a second scheme based on the respective priority of each of the plurality of radio channels. Preferably, the first sensing procedure is performed prior to performing the second sensing procedure.

In some examples the first scheme is a round-robin scheme, wherein for example the second scheme is not round-robin based.

In some examples, the method comprises at least one of: a) at least temporarily using a single observer for performing the respective sensing operation for each of the plurality of radio channels based on the respective assigned priority, or b) at least temporarily using multiple observers for performing the respective sensing operation for each of the plurality of radio channels based on the respective assigned priority.

In some examples, an observer may be an entity or component that is configured to monitor and/or analyze a radio channel, e.g., to gather information about its current state.

In some examples, the method comprises: providing a scheduling algorithm associated with the multiple observers, and, optionally, using the provided scheduling algorithm.

In some examples, the method comprises: providing different observation times for the different radio channels, and, optionally, using the different observation times for sensing of the different radio channels.

Some examples relate to an apparatus for processing data associated with a plurality of radio channels, wherein the apparatus is configured to perform the method according to the disclosure, wherein for example the apparatus comprises means for performing the method according to the disclosure.

Some examples relate to a device for a wireless communication system comprising the apparatus according to the disclosure.

Some examples relate to a computer program comprising instructions which, when the program is executed by a computer, cause the computer to perform the method according to the disclosure.

Some examples relate to a computer-readable storage medium, for example a non-transitory computer-readable storage medium, which comprises computer-readable instructions that, when executed by a computer, cause the computer to perform the method according to the disclosure.

Some examples relate to a data-carrier signal carrying and/or characterizing the computer program according to the disclosure.

Some examples relate to a use of the method according to the disclosure and/or of the apparatus according to the disclosure and/or of the device according to the disclosure and/or of the computer program according to the disclosure and/or of the computer-readable storage medium according to the disclosure and/or of the data-carrier signal according to the disclosure for at least one of: a) determining a quality of radio channels, or b) determining, e.g., constructing, a channel quality list, or c) prioritizing channel sensing, or d) adapting an observation time for sensing a respective channel, or e) enhancing at least one of e1) an efficiency, or e2) an adaptability, or e3) a performance of a channel observation process.

### BRIEF DESCRIPTION OF THE DRAWINGS

Some example embodiments will now be described with reference to the figures.

FIG. 1 schematically depicts a simplified flow-chart, according to an example embodiment.

FIG. 2 schematically depicts a simplified block diagram, according to an example embodiment.

FIG. 3 schematically depicts a simplified flow-chart, according to an example embodiment.

FIG. 4 schematically depicts a simplified flow-chart, according to an example embodiment.

FIG. 5 schematically depicts a simplified flow-chart, according to an example embodiment.

FIG. 6 schematically depicts a simplified flow-chart, according to an example embodiment.

FIG. 7 schematically depicts a simplified flow-chart, according to an example embodiment.

FIG. 8 schematically depicts a simplified block diagram, according to an example embodiment.

FIG. 9 schematically depicts a time diagram, according to an example embodiment.

FIG. 10 schematically depicts example aspects of use of the present disclosure.

### DETAILED DESCRIPTION OF EXAMPLE EMBODIMENTS

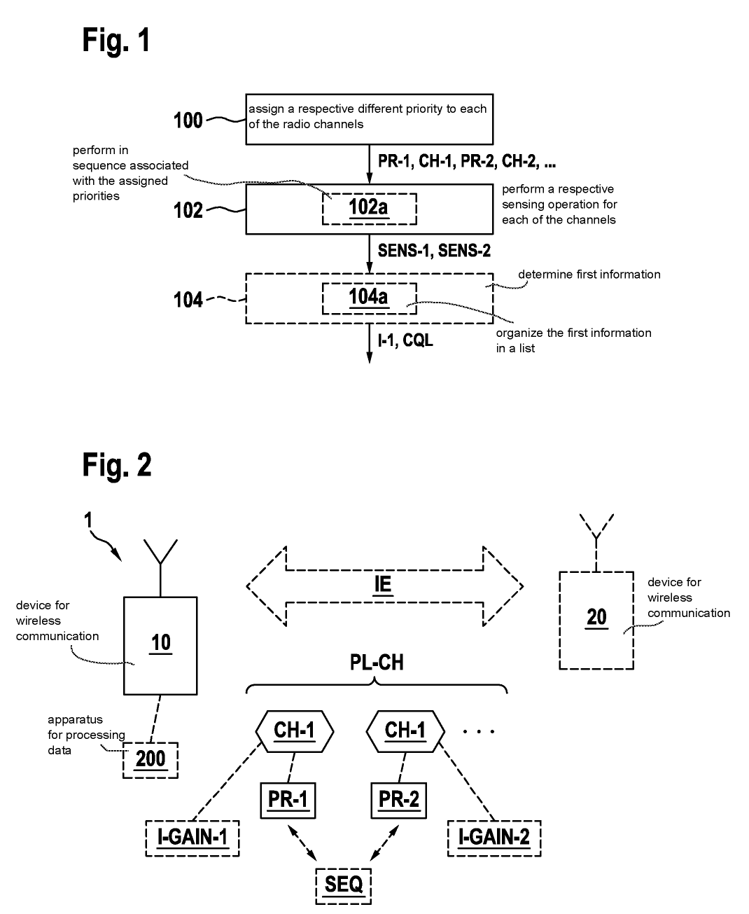

Some examples, see, for example, see FIG. 1, 2, relate to a method, for example a computer-implemented method, for processing data associated with a plurality PL-CH (FIG. 2) of radio channels CH-1 ,CH-2, …, the method comprising: assigning 100 (FIG. 1) a respective different (e.g., individual) priority PR-1, PR-2, … to each of the plurality PL-CH of radio channels CH-1, CH-2, …, performing 102 a respective sensing operation SENS-1, SENS-2, … for each of the plurality PL-CH of radio channels based on the respective assigned priority PR-1, PR-2, …. In some examples, this may enable to adapt a sensing procedure or strategy to a priority PR-1, PR-2 associated with a respective radio channel. In some examples, the radio channels may at least temporarily be used for communication, e.g., as communication channels, e.g., between at least two devices 10, 20 capable of wireless information exchange IE via at least one radio channel CH-1, CH-2, ….

Note that "respective different priority PR-1, PR-2" does not necessarily imply that different channels only may comprise different priorities. Rather, in some examples, different channels may, at least in some cases, comprises a same priority, e.g., depending on a procedure how to obtain the priority. However, in some examples, it is important to note

that individual priorities are assigned to the different channels. In other words, at least some, e.g., all, channels CH-1, CH-2, … may comprise a respective individual, e.g., "own", priority (which, in some cases, may be equal to a priority of at least one other channel, and which in some other cases, may not be equal to a priority of at least one other channel).

In some examples, see FIG. 2, at least some aspects of the disclosure, e.g., of the method according to the disclosure, may at least temporarily be performed by an apparatus 200. In some examples, the apparatus 200 or a respective functionality may be provided for, e.g., within, at least one of the devices 10, 20.

In some examples, see FIG. 1, performing 102 the respective sensing operation SENS-1, SENS-2, … for each of the plurality of radio channels comprises performing 102a the respective sensing operation for each of the plurality of radio channels in a sequence SEQ (FIG. 2) associated with the respective assigned priority PR-1, PR-2, …, wherein for example the sequence SEQ is arranged in order of decreasing priority. In some examples, this enables to sense such radio channels first which are associated with a comparatively high priority.

The optional block 104 of FIG. 1 symbolizes determining first information I-1, e.g., representing channel quality, e.g., in the form of a channel quality list CQL, e.g., based on the sensing operations SENS-1, SENS-2, …, see block 102.

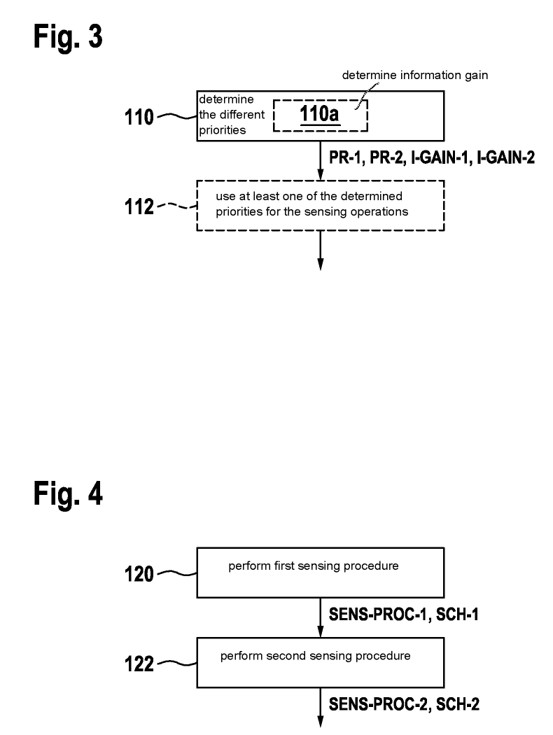

In some examples, see FIG. 3, the method comprises: determining 110 the different priorities PR-1, PR-2, … for the plurality PL-CH of radio channels based on at least one of: a) an information gain I-GAIN-1, I-GAIN-2, … associated with the respective radio channel CH-1, CH-2, …, or b) a time since the respective radio channel was last sensed.

The optional block 112 of FIG. 3 symbolizes an optional use of at least one of the determined priorities PR-1, PR-2, … for the sensing operations SENS-1, SENS-2, …, also see block 102 of FIG. 1.

In some examples, see FIG. 3, the method comprises: determining 110a the information gain I-GAIN-1, I-GAIN-2, … associated with the respective radio channel based on a change of a channel quality associated with the respective radio channel, e.g., based on a difference of a channel quality, e.g., before and after sensing, e.g., according to at least one predetermined scheme SCH-1, SCH-2, also see some examples disclosed further below, e.g., with respect to FIG. 4.

In some examples, see FIG. 1, as already mentioned above, the method comprises: determining 104 the first information I-1 characterizing a respective quality of the respective radio channel based at least on the sensing operations, wherein for example the determining 104 comprises organizing 104a the first information I-1 in the form of a list, for example a channel quality list CQL.

In some examples, see FIG. 4, the method comprises: performing 120 a first sensing procedure SENS-PROC-1 for sensing the plurality of radio channels using a first scheme SCH-1, wherein for example the first scheme SCH-1 is independent of the respective priority of each of the plurality of radio channels, performing 122 a second sensing procedure SENS-PROC-2 for sensing the plurality of radio channels using a second scheme SCH-2, e.g., different from the first scheme SCH-1, e.g., based on the respective priority PR-1, PR-2, … of each of the plurality of radio channels CH-1, CH-2, ….

In some examples, see FIG. 4, the first scheme SCH-1 is a round-robin scheme, wherein for example the second scheme SCH-2 is not round-robin based, e.g., not a round-robin scheme.

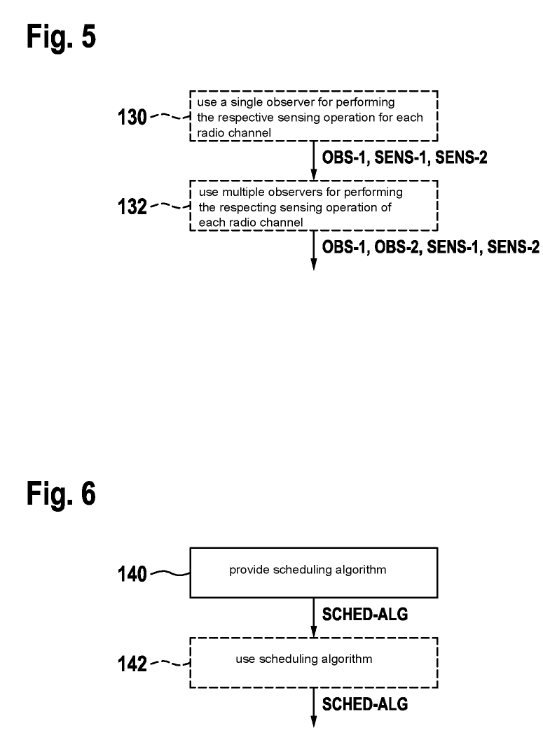

In some examples, see FIG. 5, the method comprises at least one of: a) at least temporarily using 130 a single observer OBS-1 for performing the respective sensing operation SENS-1, SENS-2 for each of the plurality PL-CH of radio channels based on the respective assigned priority, or b) at least temporarily using 132 multiple observers OBS-1, OBS-2 for performing the respective sensing operation SENS-1, SENS-2 for each of the plurality PL-CH of radio channels based on the respective assigned priority.

In some examples, an observer OBS-1, OBS-2 may be an entity or component that is configured to monitor and/or analyze a radio channel CH-1, CH-2, …, e.g., to gather information about its current state.

In some examples, see FIG. 6, the method comprises: providing 140 a scheduling algorithm SCHED-ALG associated with the multiple observers OBS-1, OBS-2, and, optionally, using 142 scheduling algorithm SCHED-ALG. This enables to provide further degrees of freedom for the sensing operations SENS-1, SENS-2. In some examples, the scheduling algorithm SCHED-ALG may, e.g., determined, which observer of the plurality of observers should observe which channel.

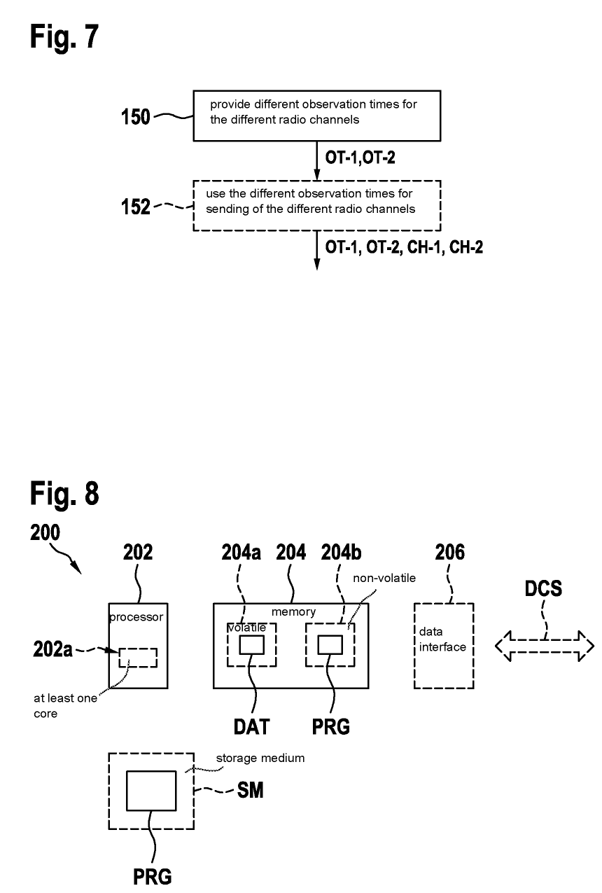

In some examples, see FIG. 7, the method comprises: providing 150 different observation times OT-1, OT-2 for the different radio channels CH-1, CH-2, and, optionally, using 152 the different observation times OT-1, OT-2 for sensing of the different radio channels. In some examples, this may, e.g., enable to perform channel sensing with different durations or sensing or observation times, e.g., for different channels. In some examples, the different observation times OT-1, OT-2 may, e.g., be determined based at least on a respective priority PR-1, PR-2, ….

Some examples, see FIG. 8, relate to an apparatus 200 for processing data associated with a plurality PL-CH (FIG. 2) of radio channels CH-1, CH-2, …, wherein the apparatus 200 is configured to perform the method according to the disclosure, wherein for example the apparatus 200 comprises means 202, 204, PRG for performing the method according to the disclosure.

In some examples, see FIG. 8, the apparatus 200 comprises at least one calculating unit, e.g. processor, 202 (comprising, e.g., at least one core 202a) and at least one memory unit 204 associated with (i.e., usable by) the at least one calculating unit 202 for at least temporarily storing a computer program PRG and/or data DAT, wherein the computer program PRG is e.g. configured to at least temporarily control an operation of at least one of the apparatus 200 or device 10, respectively, e.g. in the sense of an execution of a method according to the disclosure.

In some examples, see FIG. 8, the at least one calculating unit 202 may comprise at least one of the following elements: a microprocessor, a microcontroller, a digital signal processor (DSP), a programmable logic element (e.g., FPGA, field programmable gate array), an ASIC (application specific integrated circuit), hardware circuitry, a tensor processor, a graphics processing unit (GPU). According to further examples, any combination of two or more of these elements is also possible.

In some examples, see FIG. 8, the memory unit 204 comprises at least one of the following elements: a volatile memory 204a, particularly a random-access memory (RAM), a non-volatile memory 204b, particularly a Flash-EEPROM.

In some examples, see FIG. 8, the computer program PRG is at least temporarily stored in the non-volatile memory 204b. Data DAT (e.g. associated with at least one of a) the sensing operations SENS-1, SENS-2, or b) the first information I-1, or c) any further information PR-1, PR-2, …, I-GAIN-1, I-GAIN-2, or data associated with the principle according to the disclosure), which may, e.g., be used for executing the method according to the disclosure, may at least temporarily be stored in the RAM 204a.

In some examples, see FIG. 8, an optional computer-readable storage medium SM, e.g., a non-transitory computer-readable storage medium SM, comprising instructions, e.g., in the form of the computer program PRG, may be provided. As an example, the storage medium SM may comprise or represent a digital storage medium such as a semiconductor memory device (e.g., solid state drive, SSD) and/or a magnetic storage medium such as a disk or harddisk drive (HDD) and/or an optical storage medium such as a compact disc (CD) or DVD (digital versatile disc) or the like.

In some examples, see FIG. 8, the apparatus 200 may, e.g., comprise an optional data interface 206, e.g. for bidirectional data exchange with an external device (not shown). As an example, by means of the optional data interface 206, a data carrier signal DCS may be exchanged, e.g. with the external device, for example via a wired or a wireless data transmission medium (e.g., associated with a communication system 1 (FIG. 2) comprising the devices 10, 20), e.g. over a (virtual) private computer network and/or a public computer network such as, e.g., the Internet.

Some examples, see FIG. 2, relate to a device 10 for a wireless communication system 1 comprising the apparatus 200 according to the disclosure.

Some examples, see FIG. 8, relate to a computer program PRG comprising instructions which, when the program PRG is executed by a computer 202, cause the computer 200 to perform the method according to the disclosure.

Some examples, see FIG. 8, relate to the computer-readable storage medium SM.

Some examples, see FIG. 8, relate to the data-carrier signal DCS carrying and/or characterizing the computer program PRG according to the disclosure.

In the following, further aspects and examples are provided, which, in some examples, may be combined with each other and/or with at least one of the aforementioned aspects or examples.

In some examples, the principle of the disclosure may be used to at least temporarily improve at least some aspects of conventional procedures of constructing channel quality lists. As an example, some conventional approaches for constructing channel quality lists are comparatively time-consuming, particularly when dealing with many channels. This inefficiency of at least some conventional approaches may, e.g., hinder an overall performance and scalability of the conventional systems. Secondly, in some conventional approaches, observer mechanisms may be comparatively inefficient, thus, e.g., preventing to optimize an allocation of resources. Moreover, in at least some conventional approaches, an observation time is a manually configured parameter, which does not automatically adjust, e.g., to changing channel conditions. Thus, in some conventional approaches, a lack of adaptability limits an accuracy and effectiveness of channel quality lists as obtained by the conventional approaches.

By contrast, the principle of the disclosure enables to mitigate, e.g., overcome, at least some of these shortcomings of at least some conventional approaches, e.g., by providing one or more innovative aspects that may, e.g., enhance at least one of a) an efficiency, or b) an adaptability, or c) an overall performance of a channel observation process.

In some examples, the principle of the disclosure may enable to improve a construction of channel quality lists CQL (see optional block 104 of FIG. 1), e.g., by offering one or more significant advantages over at least some existing systems. One key advantage according to some examples is a prioritization of channel observation, e.g., based on an information gain I-GAIN-1, I-GAIN-2 (FIG. 2, 3), e.g., unlike at least some conventional approaches that permanently allocate equal time to all channels. In some examples, a prioritization of at least some channels may, e.g., optimize a resource utilization, thus, e.g., leading to improved accuracy, e.g., in the channel quality list CQL. Additionally, some examples according to the disclosure may, e.g., reduce an overall duration of a channel quality list construction process, e.g., by adapting a respective observation time (see, for example, FIG. 7) OT-1, OT-2, e.g., to each channel's specific characteristics. In some examples, channels with higher uncertainty or potential for improvement may, e.g., be observed more frequently, while channels with lower uncertainty may, e.g., be observed using less observation time. In some examples, this comparatively time-efficient approach may, e.g., maintain an accuracy of the channel quality list CQL, while at the same time addressing potential limitations that may, e.g., be imposed by limited hardware resources.

In some examples, two variants based on the principle of the disclosure may be provided: a first variant with a single observer OBS-1 (see, for example, FIG. 5, block 130), and a second variant with multiple (e.g., two or more) observers OBS-1, OBS-2 (see, for example, FIG. 5, block 132). In some examples, this flexibility may, e.g., allow to adapt to different hardware configurations and to scale accordingly.

To summarize, in some examples, the principle according to the disclosure may enable to at least temporarily offer at least some advantages, e.g., by at least one of: a) prioritizing channel observation based on information gain, or b) reducing construction time for channel quality lists, or c) accommodating various hardware configurations. In some examples, one or more of these advancements may, e.g., enhance at least one of accuracy, or efficiency, or scalability, e.g., in constructing channel quality lists.

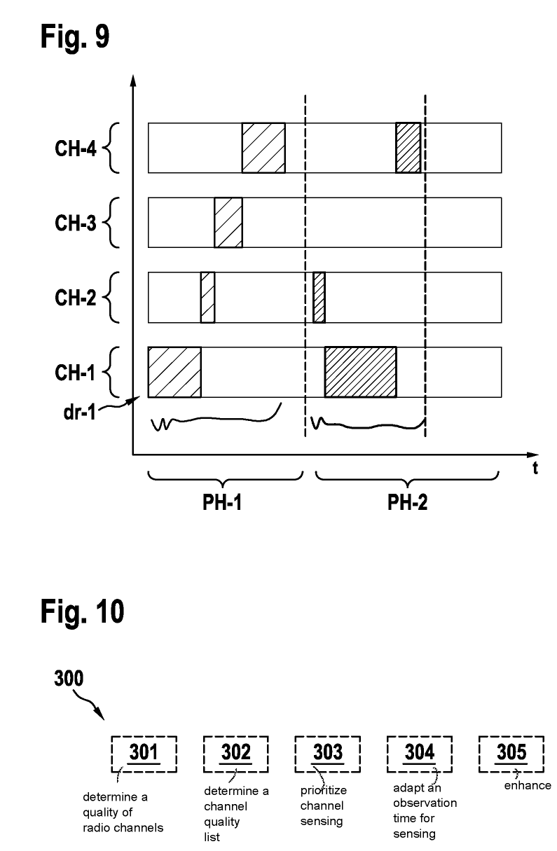

In some examples, a procedure according to the disclosure may, e.g., be divided into two phases, see, for example FIG. 4 and FIG. 9. FIG. 9 schematically depicts aspects of sensing channels CH-1, CH-2, CH-3, CH-4 according to some examples. In a first phase PH-1, a first scheme SCH-1 (also see, for example, block 120 of FIG. 4) is used for the sensing, e.g., according to a round-robin scheme, wherein the first channel CH-1 is sensed first, see the dashed rectangle dr-1 associated with the first channel CH-1, and, after that, the second channel CH-2 is sensed, and so on.

By contrast, in a second phase PH-2 (FIG. 9), e.g., subsequent to the first phase PH-1, a different second scheme SCH-2 (also see, for example, block 122 of FIG. 4) for sensing the channels CH-1, CH-2, CH-3, CH-4 is used, which is based on a respective priority PR-1, PR-2, … (FIG. 2) associated with the channels CH-1, CH-2, CH-3, CH-4. As can be seen from FIG. 9, in the present example, in the second phase PH-2, the second channel CH-2 is sensed first, after that, the first channel CH-1 is sensed, and, after that, the fourth channel CH-4 is sensed. In some examples, at least one channel, presently for example the third channel, CH-3, may not be sensed, e.g., according to the second scheme SCH-2.

Thus, in some examples, see FIG. 9, in the first phase PH-1, an initialization process may begin with a round-robin approach over the channels CH-1, CH-2, CH-3, CH-4, e.g., until each channel has been sensed 𝑛 times, n >=1, e.g., each time for a, for example predetermined, duration of 𝑑. In some examples, an overall duration of the first phase PH-1 may, e.g., be determined by a product of the number of channels (𝑁𝑐ℎ), e.g., presently four, the number of sensing instances (𝑁𝑠𝑒𝑛𝑠𝑒), the switching time (𝑡𝑠𝑤𝑖𝑡𝑐ℎ), and the sensing duration (𝑑). In some examples, this overall duration may be a trade-off, e.g., considering a system-specific value of the switching time 𝑡𝑠𝑤𝑖𝑡𝑐ℎ, which, e.g., represents a time required for a radio system (e.g., of the device 10, see FIG. 1) to switch between different channels.

In some examples, a sensing efficiency may be calculated, e.g., as a ratio of the duration 𝑑 to the sum of the duration d and the switching time 𝑡𝑠𝑤𝑖𝑡𝑐ℎ, e.g., as 𝑑/(𝑡𝑠𝑤𝑖𝑡𝑐ℎ + 𝑑), representing the efficiency of the sensing process according to some examples. In some examples, the overall duration may be found as 𝑁𝑠𝑒𝑛𝑠𝑒𝑁𝑐ℎ ⋅ (𝑡𝑠𝑤𝑖𝑡𝑐ℎ + 𝑑).

In the second phase PH-2, see FIG. 9, as mentioned above, a priority-based channel observation for at least some of the channels CH-1, CH-2, CH-3, CH-4 may take place. In some examples, the channel with the highest priority is selected for observation, presently for example channel CH-2. In some examples, as already mentioned above, the priority PR-1, PR-2, … of a channel CH-1, CH-2, … may be determined based on at least two factors: a) information gain, or b) a time since the channel was last sensed. In some examples, the information gain may, e.g., refer to an accumulation of knowledge about

the channels. In some examples, this measure may, e.g., help to identify those channels that, e.g., through sensing them, may provide the most valuable information, e.g., for constructing the channel quality list CQL. In some examples, the information gain may, e.g., be computed based on a difference in assigned channel qualities, e.g., before sensing and after sensing. For example, if channels are rated through means of classification, i.e. whether they belong to a particular quality category out of, e.g., 𝑛 categories, then, in some examples, a probability distribution may indicate the probabilities of one channel belonging to any particular quality category. In some examples, the least information is available if this distribution is uniform, i.e. the probabilities of the channel belonging to any category is identical for all categories. In some examples, most information about a channel may, e.g., be available if a probability of the channel belonging to one quality category is 100%, and 0% for all other quality categories.

In some examples, e.g., after sensing a channel, additional knowledge may be gained, and the probability distribution might have changed. In some examples, the information gain may, e.g., be at least one of: a) an amount of change, or b) a distance of a current classification probability distribution to a uniform distribution.

In some examples, priority-based channel observation may be performed using one, e.g., single, observer OBS-1, also see, for example, block 130 of FIG. 5. In some examples, the single observer OBS-1 may select and observe the channel with the highest priority based on the information gain and time since the last sensing. In some examples, the information gain may, e.g., be measured by a reduction in an empirical risk. In some examples, this may, e.g., ensure an efficient utilization of resources while prioritizing channels with the highest

uncertainty. In some examples, "uncertainty" in this context may mean an uncertainty with respect to a correct channel quality category. In some examples, at least one of a) the priority, or b) the uncertainty may, e.g., be provided by another device (not shown). Thus, in some examples, determining the priority PR-1, PR-2, … may comprise receiving information from at least one further, e.g., the another, device.

In some other examples, multiple observers OBS-1, OBS-2 (also see, for example, block 132 of FIG. 5) may be used, wherein, in some examples, a scheduling algorithm SCHED-ALG (see, for example, FIG. 6) for these multiple observers may be provided. One possibility for an example scheduling algorithm SCHED-ALG according to some examples is sorting the channels according to their uncertainties, and assigning the observers to sensing the most-uncertain channels in that order, wherein, for example, it may be avoided to sense a same channel using several observers simultaneously. However, in other examples, other scheduling algorithms are possible, such as, e.g., allocating some observers to sense channels with a comparatively high uncertainty, and the remaining observers may be used to sense channels that have not been sensed in a long time, so that, for example, it may be checked whether the respective channel conditions have changed.

In some examples, an observation process may be enhanced by distributing a workload associated with channel sensing among multiple observers, thus, e.g., potentially improving an overall efficiency and/or accuracy, e.g., of constructing the channel quality list CQL.

In some examples, see FIG. 9, by implementing the abovementioned two phases PH-1, PH-2, some examples may, e.g., optimize an initialization process, thus, e.g., introducing a priority-based observation approach, and optionally also offering flexibility in utilizing either a single observer or multiple observers. In some examples, one or more of these mechanisms according to the examples may, e.g., enhance an efficiency and/or accuracy of constructing a channel quality list CQL, e.g., but not limited to, WiFi systems.

Some examples, see FIG. 10, relate to a use 300 of the method according to the disclosure and/or of the apparatus 200 according to the disclosure and/or of the device 10 according to the disclosure and/or of the computer program PRG according to the disclosure and/or of the computer-readable storage medium SM according to the disclosure and/or of the data-carrier signal DCS according to the disclosure for at least one of: a) determining 301 a quality of radio channels, or b) determining 302, e.g., constructing, a channel quality list CQL, or c) prioritizing 303 channel sensing, or d) adapting 304 an observation time for sensing a respective channel, or e) enhancing 305 at least one of e1) an efficiency, or e2) an adaptability, or e3) a performance of a channel observation process.

What is claimed is:

1. A computer-implemented method for processing data associated with a plurality of radio channels, the method comprising the following steps:
assigning a respective different priority to each of the plurality of radio channels; and
performing a respective sensing operation for each of the plurality of radio channels based on the assigned respective priority.

2. The method according to claim 1, wherein the performing of the respective sensing operation for each of the plurality of radio channels includes performing the respective sensing operation for each of the plurality of radio channels in a sequence associated with the assigned respective priorities, wherein the sequence is arranged in order of decreasing priority.

3. The method according to claim 1, further comprising:
determining the respective different priorities for each respective radio channel of the plurality of radio channels based on at least one of:
an information gain associated with the respective radio channel, or
a time since the respective radio channel was last sensed.

4. The method according to claim 3, further comprising:
determining the information gain associated with the respective radio channel based on a change of a channel quality associated with the respective radio channel.

5. The method according to claim 1, further comprising:
determining respective first information characterizing a respective quality of each of the plurality of radio channels based at least on the respective sensing operations;
wherein the determining of the respective first information includes organizing the respective first information in a channel quality list.

6. The method according to claim 1, further comprising:
performing a first sensing procedure for sensing the plurality of radio channels using a first scheme, wherein the first scheme is independent of the assigned respective priority of each of the plurality of radio channels;
performing a second sensing procedure for sensing the plurality of radio channels using a second scheme based on the assigned respective priority of each of the plurality of radio channels;
wherein, preferably, the first scheme is a round-robin scheme, and wherein the second scheme is not round-robin based.

7. The method according to claim 1, further comprising at least one of:
a) at least temporarily using a single observer for performing the respective sensing operation for each of the plurality of radio channels based on the assigned respective priority, or
b) at least temporarily using multiple observers for performing the respective sensing operation for each of the plurality of radio channels based on the assigned respective priority.

8. The method according to claim 7, comprising:
providing a scheduling algorithm associated with the multiple observers; and
using the provided scheduling algorithm.

9. The method according to claim 1, further comprising:
providing different observation times for each of the plurality of radio channels; and
using the different observation times for sensing of the plurality of radio channels.

10. An apparatus for processing data associated with a plurality of radio channels, wherein the apparatus is configured to perform a method comprising the following steps:
assigning a respective different priority to each of the plurality of radio channels; and
performing a respective sensing operation for each of the plurality of radio channels based on the assigned respective priority.

11. A device for a wireless communication system, comprising:
an apparatus for processing data associated with a plurality of radio channels, wherein the apparatus is configured to perform a method including the following steps:
assigning a respective different priority to each of the plurality of radio channels; and
performing a respective sensing operation for each of the plurality of radio channels based on the assigned respective priority.

12. A non-transitory computer-readable storage medium on which are stored computer-readable instructions for processing data associated with a plurality of radio channels, the instructions, when executed by a computer, causing the computer to perform the following steps:
assigning a respective different priority to each of the plurality of radio channels; and
performing a respective sensing operation for each of the plurality of radio channels based on the assigned respective priority.

13. The method according to claim 1, wherein the method is used for at least one of:
a) determining a quality of radio channels, or
b) determining a channel quality list, or
c) prioritizing channel sensing, or
d) adapting an observation time for sensing a respective channel, or
e) enhancing at least one of e1) an efficiency, or e2) an adaptability, or e3) a performance of a channel observation process.
